(19) United States
(12) Patent Application Publication
(10) Pub. No.: US 2016/0060467 A1
(43) Pub. Date: Mar. 3, 2016

(54) FORMULATION AND METHOD FOR FABRICATING A TRANSPARENT FORCE SENSING LAYER

(71) Applicants: SYMBOL TECHNOLOGIES, INC., Schaumburg, IL (US); EVONIK INDUSTRIES AG, Hanau-Wolfgang (DE)

(72) Inventors: Aroon V. Tungare, Winfield, IL (US); Yi Wei, Saint James, NY (US); Sven Hill, Aschaffenburg (DE)

(21) Appl. No.: 14/470,475

(22) Filed: Aug. 27, 2014

(51) Int. Cl. C09D 5/24; C09D 171/00; G06F 3/041

(52) U.S. Cl. CPC C09D 5/24; G06F 3/0414; C09D 171/00

(57) ABSTRACT

A method and formulation for fabricating a transparent force sensing (TFS) layer is provided. The TFS layer is fabricated by preparing a formulation for a transparent polymer-conductor composite (TPCC). The TPCC formulation comprises transparent conducting oxide (TCO) nanoparticles, a first solvent for forming a dispersion of the TCO nanoparticles and having an intermediate boiling point ranging from one hundred and twenty five (125) to one hundred and ninety nine (199) degrees centigrade, at least one additive to prevent agglomeration of the TCO nanoparticles, a second solvent for facilitating dissolving of the at least one additive, a third solvent having a high boiling point above one hundred and ninety nine (199) degrees centigrade and a transparent polymer dissolved in the first and third solvents. The TPCC formulation is disposed on a substrate forming a wet film and dried to form a dry film.

### FIELD

The present invention generally relates to pressure sensors and more particularly to a transparent pressure sensor.

### BACKGROUND OF THE INVENTION

Today, in many electronic devices, such as portable communication devices, touch panel displays (touch screens) present information to a user and also receive input from the user. A touch screen is especially useful in portable communication devices where other input devices, such as a keyboard and a mouse, are not easily available.

There are many different types of touch sensing technologies in use, including capacitive, resistive, infrared, and surface acoustic wave. These technologies sense the position of touches on a screen. One further implementation that provides location information is a force sensing resistor based on a transparent layer. A transparent force sensing layer is particularly suitable for use with touch screens. Accordingly, there is a need to formulate and fabricate a transparent force sensing layer in a manner that is suitable for use with variety of touch screen materials.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a cross-section of a transparent force sensing layer in accordance with some embodiments.

FIG. 2 is a flowchart of a method of fabricating a transparent force sensing layer in accordance with some embodiments

FIG. 3 is a flowchart of a method of preparing a transparent conductive oxide nanoparticle dispersion in accordance with some embodiments.

FIG. 4 is a flowchart of a method of preparing a polymer solution in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The formulation and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A method and formulation for fabricating a transparent force sensing (TFS) layer is provided. The TFS layer is fabricated by preparing a formulation for a transparent polymer-conductor composite (TPCC). The TPCC formulation comprises transparent conducting oxide (TCO) nanoparticles, a first solvent for forming a dispersion of the TCO nanoparticles and having an intermediate boiling point ranging from one hundred and twenty five (125) to one hundred and ninety nine (199) degrees centigrade, at least one additive to prevent agglomeration of the TCO nanoparticles, a second solvent for facilitating dissolving of the at least one additive, a third solvent having a high boiling point above one hundred and ninety nine (199) degrees centigrade and a transparent polymer dissolved in the first and third solvents. The TPCC formulation is disposed on a substrate forming a wet film and subsequently dried to form a dry film.

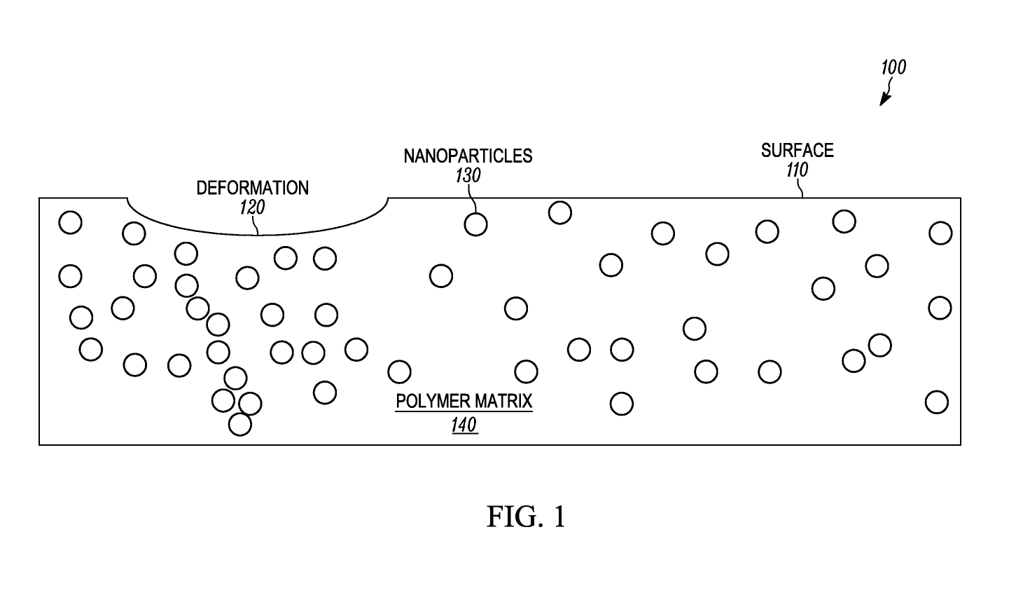

Referring to FIG. 1, a TFS layer 100 is disclosed. The TFS layer 100 may be implemented in various electronic devices having touch sensitive displays including, but not limited to, mobile computers, computer monitors, mobile phones, personal digital assistants (PDAs), and service terminals. The TFS layer 100 may be provided as, for example, part of a touch screen, in the form of a layer coating a substrate which forms a part of the touch sensitive display. The TFS layer 100 may also be provided, as another example, to be part of a display in the form of a layer coating a substrate in the display.

The TFS layer 100 is configured to enable the detection of touch as provided by a local pressure exerted on a surface 110 of the TFS layer 100. The TFS layer 100 accordingly allows a time and a location of touch inputs to be detected as well as applied forces associated with the touch inputs. Accordingly, the TFS layer 100 allows the detection of force sensitive input.

In one implementation, the TFS layer 100 is a force-sensing transparent polymer-conductor composite (TPCC). For example, the TPCC, as shown in FIG. 1, may comprise transparent conducting oxide (TCO) nanoparticles 130 dispersed in a transparent polymer matrix 140.

The TCO nanoparticles 130 of the TPCC provide a conducting path through the TPCC. For example, current can flow through the TPCC via the TCO nanoparticles 130, either directly when the nanoparticles 130 are in contact with each other, or by tunneling when the particles are separated by a very small distance. When pressure is applied to the TPCC, the TPCC deforms, as indicated at 120, and increases the number of conductive paths, thereby lowering the resistance. The resistance may be measured by electrodes or similar sensors (not shown) placed on or in the TPCC 120, providing an indication of applied force.

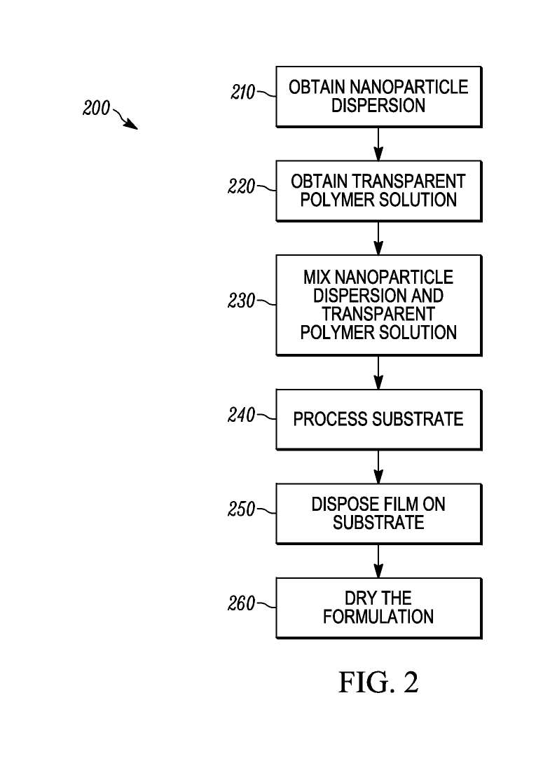

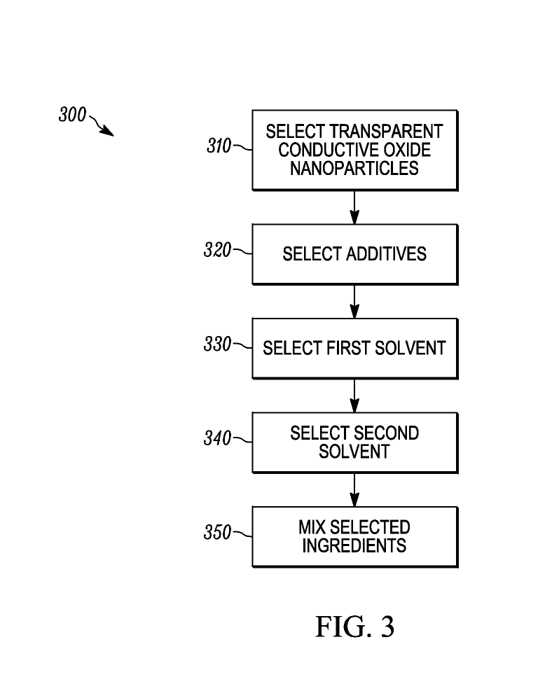

Referring now to FIG. 2, a method 200 for fabricating the TFS layer 100 is illustrated. At 210, a TCO nanoparticle dispersion is obtained. FIG. 3 illustrates an exemplary method 300 of obtaining a TCO nanoparticle dispersion. At 310, the TCO nanoparticles 130 are selected. In some implementations, the TCO nanoparticles 130 may be indium tin oxide (ITO). In other implementations, for example, the TCO nanoparticles may be zinc oxide (ZnO) or tin dioxide (SnO2). In variations, TCO nanoparticles 130 may be a combination of different transparent nanoparticle compounds. In some implementations, the nanoparticles 130 may be sized less than 100 nanometer (nm).

At 320, one or more additives are selected. In some implementations, the first additive may be a carboxylic acid such as [2-(2-Methoxyethoxy)ethoxy]acetic acid (CAS-No. 16024-58-1 EC No. 240-162-1) and the second additive may be an inorganic acid such as Nitric Acid. The additives are selected so as to prevent agglomeration of the TCO nanoparticles 130 in the dispersion. Specifically, the additives act as dispersing agents for the TCO nanoparticles 130 and promote formation of a stable dispersion. The amount and weight ratio of the additives used may be varied based on the type of TCO nanoparticles used to form the dispersion.

At 330, a first solvent is selected. The first solvent is an intermediate boiling point solvent, the use of which allows the fabrication of the TFS layer 100 on a wide variety of substrates. For example, intermediate boiling point solvents may allow the fabrication process to be carried out using temperatures lower than the formulations that rely on high boiling point solvents. Carrying out fabrication at lower temperatures, in turn, allow the TFS layer 100 to be deposited on a wider variety substrates such as plastic substrates, including Polycarbonate (PC) and Polyethylene terephalate (PET) substrates typically used in the touch panel construction. In addition to lower temperature fabrication, the first solvent allows a more rapid solvent removal in comparison with a high boiling point solvent, for example. Accordingly, the fabrication times are also reduced.

The intermediate boiling point solvents have a boiling point ranging from one hundred and twenty five (125) to one hundred and ninety nine (199) degrees centigrade inclusive. For example, the first solvent may be dipropylene glycol methyl ether which has a boiling point of approximately one hundred and ninety (190) degrees centigrade, or any other suitable solvent having similar solvent qualities. High boiling point solvents, on the other hand, have a boiling point of two hundred (200) degrees centigrade or above and include, for example, propylene glycol phenyl ether) which has a boiling point of two hundred and forty one (241) degrees centigrade, or any other suitable solvent having similar solvent qualities.

Continuing with the method 300 at 340, a second solvent is selected. The second solvent is a solvent that further facilitates the dissolving of the first and second additives in the TCO nanoparticle dispersion. For example, the second solvent may be diacetone alcohol (DAA, CAS No. 123-42-2), or any other suitable solvent having similar solvent qualities.

Continuing with method 300, at 350, the ingredients selected, for example, the selected TCO nanoparticles 130, the two selected solvents and the two selected additives, are mixed to form a TCO nanoparticle dispersion. The mixing may be carried out using a high shear mixer, or equivalent mixers with a high shear force, for example. In some implementations, the ratio, by weight, of the resulting TCO nanoparticle dispersion may be 45.98% nanoparticles, 39.20% intermediate boiling point solvent, 10.22% second solvent, 3.45% first additive and 1.15% second additive. It will be appreciated by those of ordinary skill in the art that alternatively the weight ratio of each component may vary.

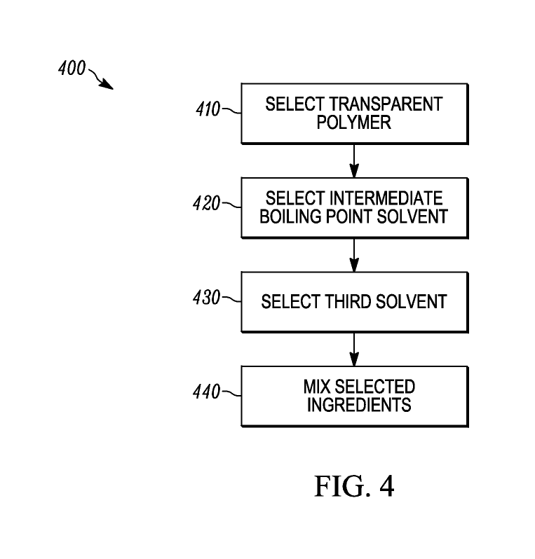

Referring back to FIG. 2 and continuing with the method 200, At 220, a transparent polymer solution is obtained. Referring to FIG. 4, an example method 400 of obtaining a transparent polymer solution is illustrated. At 410 a transparent polymer is selected. For example, transparent polymers that may be used with the present invention include, but are not limited to, phenoxy resin, polyethers, acrylic, silicone, lacquer or other types of transparent elastomers, or combinations thereof. In one implementation the phenoxy resin PKHH (CAS No. 25068-38-6) may be used.

At 420 an intermediate boiling point solvent is selected. The intermediate-boiling point solvent may be substantially similar to the first solvent discussed in relation to method 200. Accordingly, the intermediate boiling point solvent may be a solvent such as dipropylene glycol methyl ether (boiling point of 190 degrees centigrade), or any other suitable solvent having similar solvent qualities.

Continuing with the method 400, at 430 a third solvent is selected. The third solvent is a high boiling solvent that further facilitates the dissolving of the transparent polymer and thus the formation of a clear TFS layer 100. For example, the addition of the third solvent to dipropylene glycol methyl ether may reduce the haziness and increase transparency of the TFS 100 layer. Accordingly, the third solvent to intermediate boiling point solvent may be selected to yield a clear TFS 100 layer. The third solvent may be, for example, propylene glycol phenyl ether (boiling point 241 degrees centigrade), or any other suitable solvent having similar solvent qualities.

At 440, the selected ingredients, for example the transparent polymer and the solvents selected are mixed to form the transparent polymer solution. Accordingly, the selected transparent polymer is dissolved in the intermediate boiling point solvent and third solvent. The mixing may be carried out using a low shear mixer, propeller mixer, shaker or the like, for example, taking care not to introduce any air into the solution. In some implementations, the weight ratio of the transparent polymer solution may be 32.99% transparent polymer, 57.66% intermediate boiling-point solvent and 9.35% third solvent. It will be appreciated by those of ordinary skill in the art that alternatively the percent weight of each component may vary.

Referring back to FIG. 2, and continuing with the method 200, at 230, the TCO nanoparticle dispersion and the transparent polymer solution obtained are mixed to form a TPCC formulation. Specifically, the TCO nanoparticle dispersion and the transparent polymer solution are measured in predetermined ratios and mixed using a low shear mixer, propeller mixer, shaker or the like, while taking care not to introduce any air to form the TPCC formulation.

In one implementation, for example, the ratios are determined by a percolation point associated with the TCO nanoparticles 130 and the transparent polymer in the TFS layer 100 (e.g. the TPCC). For example, the TPCC may comprise a 2:1 weight ratio of the TCO nanoparticles 130 to the transparent polymer. In a further example, the weight ratio of the TPCC formulation may be 23.52% TCO nanoparticles 130, 54.23% intermediate boiling point solvent, 5.23% second solvent, 1.71% first additive, 0.59% second additive, 11.47% transparent polymer and 3.25% third solvent. In variations, the percent weight of each component may vary. For example, as mentioned above, the weight ratios of the first to second additive may be altered based the type of TCO nanoparticles 130 used to form the dispersion. As a further example, the weight ratio of the intermediate boiling point solvent and the third solvent used may be varied to yield a TFS layer 100 with desired optical characteristics. For example, the weight ratios of propylene glycol phenyl ether and dipropylene glycol methyl ether may be selected to yield a TFS layer 100 with a haze percentage of less than 3.5% and an optical transmission percentage (transparency) of greater than 85%, at a thickness of 7 microns. In another example, the weight ratios of propylene glycol phenyl ether and dipropylene glycol methyl ether may be selected to yield a TFS layer 100 with a haze percentage of less than 4% and an optical transmission percentage (transparency) of greater than 82%, at a thickness of 7 microns.

In some implementations, after the mixing, the resulting TPCC formulation may be, optionally, degassed (not shown in FIG. 2). In one embodiment, the degassing is performed in a vacuum chamber with light vacuum. In another embodiment, degassing of the TPCC formulation may be done under ambient air pressure. The degassing step allows for any air that may have been introduced into the TPCC formulation to be removed.

Continuing with the method 200, at 240 a substrate is processed using standard photolithography, etching, and/or screen printing process. Once the substrate is processed, the TPCC formulation is then disposed, as a wet film, onto the substrates at 250. In one embodiment, for example, a screen printing technique may be used to dispose the TPCC formulation to the substrate. Dip coating, spin coating, or any of the suitable film deposition techniques may also be used to apply the TPCC formulation onto the substrate.

In some implementations, viscosity of the TPCC formulation may be varied to accommodate different methods of disposing the TPCC formulation onto the substrate. For example, screen printing may produce improved results with higher viscosity TPCC formulations. The overall viscosity of the TPCC formulation may be adjusted to a level suitable for the screen printing process by changing the amount of dipropylene glycol methyl ether used. Accordingly, for the screen printing process, for example, the dipropylene glycol methyl ether amount used may be reduced to produce a higher solids content, and thus more viscous TPCC formulation.

Once the wet film is disposed onto the substrate, the TPCC formulation is dried by removing the solvents from the TPCC formulation as shown at 260. Various types of ovens may be used for drying the disposed TPCC formulation to form a dry TFS 100 layer, including a vacuum oven, convection oven, infrared (IR) oven and hot plate. Several heating stages may be applied to achieve a uniformly deposited film. The final temperature may range between one hundred and ten (110) and one hundred and forty (140) degrees centigrade, inclusive. For example, in one embodiment, the final solvent removal temperature of the TPCC formulation may be approximately one-hundred and twenty (120) degrees centigrade. The total time for solvent removal is typically between one to three hours.

The solvent removal is achieved through volatilization of the solvents. Solvent volatilization leaves behind a dry film of TFS layer 100. The controlled volatilization of the mixture of the three solvents allows for a uniform and smooth surface finish for the TFS layer 100. The lower temperatures used for drying the film (i.e., solvent removal) allows the use of lower cost transparent plastics substrates, e,g, substrates other than glass may be used. The shorter drying times also helps lower the overall processing costs. For example, the drying time may be approximately two hours at one hundred and thirty (130) degrees centigrade.

Typically, the dry film thickness achieved from a single disposition ranges between 1 and 10 micrometers. In some variations, TFS 100 layer may be formed through multiple film dispositions. For example, when the screen printing process is used to deposit the TPCC formulation onto the substrate, each screen printing pass deposits enough TPCC formulation so as to result in a dry film approximately two to three and a half micrometers thick. The force sensing touch panel application of the TFS layer 100, for example, typically requires a TFS layer 100 between four to twelve micrometer thickness. The disposing and the drying processes therefore, may be repeated two or more times to achieve the desired thickness for the TFS 100 layer.

In some implementations, the weight ratio of the TCO nanoparticles 130 to transparent polymer to achieve the desired force sensitivity in the dried TFS layer 100 is 2.00:1.00 by weight. In other implementations, the ratio may be 2.05:1.00. Indeed, the ratio may vary from a low of 1.80:1.00 to a high of 2.20:1.00 based on the desired electrical characteristics of the TFS 100 layer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of fabricating a Transparent Force Sensing (TFS) layer comprising:
preparing a transparent polymer-conductor composite TPCC formulation by mixing:
transparent conducting oxide (TCO) nanoparticles;
a first solvent for forming a dispersion of the TCO nanoparticles and having an intermediate boiling point ranging from one hundred and twenty five (125) to one hundred and ninety nine (199) degrees centigrade;
at least one additive to prevent agglomeration of the TCO nanoparticles;
a second solvent for facilitating dissolving of the at least one additive;
a third solvent having a high boiling point above one hundred and ninety nine (199) degrees centigrade; and
a transparent polymer dissolved in the first and third solvents;
disposing the TPCC formulation on a substrate forming a wet film; and
drying the disposed TPCC formulation.

2. The method of claim 1 wherein
the first solvent is dipropylene glycol methyl ether,
the second solvent is diacetone alcohol (DAA),
the third solvent is propylene glycol phenyl ether,
the transparent polymer is at least one of phenoxy resin, polyethers, acrylic, silicone, lacquer and transparent elastomer,
TCO nanoparticles are one of indium tin oxide (ITO), zinc oxide (ZnO) and tin dioxide (SNO2) and
the at least one additive further comprises a carboxylic acid and an inorganic acid.

3. The method of claim 1 further comprising:
selecting a ratio, by weight, of the first solvent to the third solvent to obtain desired optical characteristics for the TFS layer.

4. The method of claim 1 wherein the at least one additive comprises a first additive and a second additive, the method further comprising:
selecting a ratio, by weight, of the first additive to the second additive to based on a type of the TCO nanoparticles in the TFS layer.

5. The method of claim 1 wherein the disposing is performed using a screen printing process.

6. The method of claim 1 wherein the drying further comprises the removal of the solvents and the drying is performed at a temperature range between one hundred and ten (110) and one hundred and forty (140) degrees centigrade.

7. The method of claim 6 wherein a duration for the drying ranges between one (1) to three (3) hours.

8. The method of claim 1 further comprising:
repeating the disposing and the drying to achieve a desired thickness for the TFS layer.

9. The method of claim 8 wherein the desired thickness is between four (4) and twelve (12) micrometers.

10. The method of claim 1 further comprising:
selecting a ratio, by weight, of the TCO nanoparticles to the transparent polymer ranging between 1.8:1.0 to 2.2:1 in order to obtain a desired force sensitivity for the TFS layer.

11. A transparent polymer-conductor composite (TPCC) formulation for fabricating a transparent force sensing (TFS) layer comprising:
a first solvent having an intermediate boiling point ranging from one hundred and twenty five (125) to one hundred and ninety nine (199) degrees centigrade;
a second solvent different from the first solvent and mixed with the first solvent;
a third solvent having a high boiling point above one hundred and ninety nine (199) degrees centigrade;
a transparent polymer dissolved in the first and third solvents;
transparent conducting oxide (TCO) nanoparticles dispersed in the first and second solvents; and
at least one additive to prevent agglomeration of the TCO nanoparticles.

12. The TPCC formulation of claim 11 wherein the third solvent is for facilitating the dissolving of the transparent polymer;

13. The TPCC formulation of claim 11 wherein the second solvent is for facilitating dissolving of the at least one additive.

14. The TPCC formulation of claim 13 wherein the at least one additive further comprises a first additive and a second additive.

15. The TPCC formulation of claim 11 wherein the ratio of the TCO nanoparticles to the transparent polymer, by weight, ranges from 1.8:1 to 2.2:1 when the TPCC formulation is dried.

16. The TPCC formulation of claim 11 wherein the ratio, by weight, of the first solvent to the second solvent yields a haze percentage less than 4% and optical transmission percentage more than 82% when the TPCC formulation is dried.

17. The TPCC formulation of claim 14 wherein the ratio, by weight, of the first additive to the second additive is based on a type of TCO nanoparticles in the TFS layer.

18. The TPCC formulation of claim 11 wherein a desired viscosity of the TPCC formulation is obtained based on the included amount of the first solvent.

19. The TPCC formulation of claim 14 wherein:
the first solvent is dipropylene glycol methyl ether,
the second solvent is diacetone alcohol (DAA),
the third solvent is propylene glycol phenyl ether,
the transparent polymer is phenoxy resin PKHH
the TCO nanoparticles are transparent indium tin oxide (ITO),
the first additive is a carboxylic acid and
the second additive is an inorganic acid.

20. The TPCC formulation of claim 19 wherein
the first solvent is 54.23% of the TPCC formulation by weight,
the second solvent is 3.25% of the TPCC formulation by weight,
the third solvent is 5.23% of the TPCC formulation by weight,
the transparent polymer is 11.47% of the TPCC formulation by weight,
the TCO nanoparticles are 23.52% of the TPCC formulation by weight,
the first additive is 1.71% of the TPCC formulation by weight and
the second additive is 0.59% of the TPCC formulation by weight.
